(19) United States
(12) Patent Application Publication
(10) Pub. No.: US 2025/0284418 A1
(43) Pub. Date: Sep. 11, 2025

(54) DATA FLUSH TECHNIQUES FOR MEMORY

(71) Applicant: Micron Technology, Inc., Boise, ID (US)

(72) Inventors: Kui Ding, Shanghai (CN); Huachen Li, Shanghai (CN)

(21) Appl. No.: 19/052,030

(22) Filed: Feb. 12, 2025

Related U.S. Application Data
(60) Provisional application No. 63/561,647, filed on Mar. 5, 2024.

(51) Int. Cl. G06F 3/06

(52) U.S. Cl. CPC G06F 3/0632; G06F 3/0611; G06F 3/0679

(57) ABSTRACT

Methods, systems, and devices for data flush techniques for memory are described. For example, following a reset or initialization operation, the memory system may transfer control information from the non-volatile memory of the memory system to the working memory of the system to utilize in various operations. In some examples, while performing the operations associated with the control information, the control information may be updated. the memory system may then receive a hardware reset signal. In response to the hardware reset signal, the memory system may transfer the updated control information from the working memory to the non-volatile memory of the memory system so that the updated control information is available after the subsequent reset.

### CROSS REFERENCE

The present Application for Patent claims priority to U.S. Patent Application No. 63/561,647 by Ding et al., entitled “DATA FLUSH TECHNIQUES FOR MEMORY,” filed Mar. 5, 2024, which is assigned to the assignee hereof, and which is expressly incorporated by reference in its entirety herein.

### TECHNICAL FIELD

The following relates to one or more systems for memory, including data flush techniques for memory.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports data flush techniques for memory in accordance with examples as disclosed herein.

FIG. 2 shows an example of a process flow that supports data flush techniques for memory in accordance with examples as disclosed herein.

FIG. 3 shows an example of a timing diagram that supports data flush techniques for memory in accordance with examples as disclosed herein.

FIG. 4 shows a block diagram of a memory system that supports data flush techniques for memory in accordance with examples as disclosed herein.

FIGS. 5 and 6 show flowcharts illustrating a method or methods that support data flush techniques for memory in accordance with examples as disclosed herein.

### DETAILED DESCRIPTION

Some memory systems (e.g., not-and (NAND) memory systems) may store control information for the memory system within the memory system itself. Examples of control information may include logical-to-physical (L2P) address mapping information or management data for the memory system. The memory system may store such control information within non-volatile memory (e.g., NAND memory) of the memory system. As part of an initialization (e.g., power-on or post-reset) operation, the memory system may load (e.g., import) the control information into volatile memory (e.g., random access memory (RAM), such as static random access memory (SRAM) or dynamic random access memory (DRAM)) by reading the control information from the non-volatile memory and writing the control information to the volatile memory. A controller may access the volatile memory and use (e.g., execute, reference) the control information as loaded therein to perform (e.g., manage) one or more operations of the memory system.

As the memory system operates, aspects of the control information may change (e.g., be updated) over time. For example, L2P mapping information may change as data is read or written by a host system for the memory system. Further, at least some management data may depend on aspects of the L2P mapping information, and hence corresponding changes to the management data may occur as changes to the L2P mapping information occur. In some memory systems, following a hardware reset (e.g., after a hardware reset signal is received at the memory system), the operative (e.g., up-to-date) version of the control information may be recovered through a relatively time-intensive process, which may cause undesirable latency for the memory system or a host system (e.g., undesirable latency may be introduced for a bootup process for the host system, if the bootup process involves the issuance of one or more hardware reset signals to the memory system). For example, following a hardware rest operation, some memory systems may recover (e.g., rebuild, bring up to date) control information based on a prior, outdated version of the control information that was previously written to the non-volatile memory some time before the hardware reset signal was received (e.g., by scanning other contents of the non-volatile memory and updating the outdated version based on the results of such scanning, where such scanning may be time-intensive or otherwise inefficient).

In accordance with the techniques described herein, to decrease latency or otherwise improve the efficiency with which a memory system may resume operation following a hardware reset (which may also help reduce latency or otherwise improve a bootup process of a host system), a memory system may flush control information for the memory system from the working memory of the memory system to non-volatile memory (e.g., NAND) in response to receiving a hardware reset signal. This may ensure that the operative (e.g., current, up-to-date) version of the control information is available to be loaded (e.g., imported) into the volatile memory from the non-volatile memory following the subsequent hardware reset operation, thereby reducing the latency with which the memory system may resume operation. Thus, for example, by taking a relatively small amount of extra time to flush the operative version of the control information to non-volatile memory in response to the hardware reset signal, scanning or other time-intensive operations related to recovering the control information may be avoided after the hardware reset, resulting in a net (overall) improvement in latency and performance.

Data flush techniques for memory as described herein may improve the performance of a memory system as well as various electronic devices and systems that include the memory system (including as related to mobile devices, artificial intelligence (AI) applications, augmented reality (AR) applications, virtual reality (VR) applications, and gaming). For example, implementing the techniques described herein may improve the performance of electronic devices by improving (e.g., decreasing) the recovery time of a memory system or a host system in response to a hardware reset. As one such example, some mobile devices may use a bootup process that includes the issuance of multiple hardware reset signals to a memory system therein, and the techniques described herein may reduce the latency with which the memory system is available after a hardware reset and hence may reduce the latency of the overall bootup process for the mobile device, among other potential benefits.

Features of the disclosure are illustrated and described in the context of systems, devices, and circuits. Features of the disclosure are further illustrated and described in the context of a process flow, a timing diagram, and flowcharts.

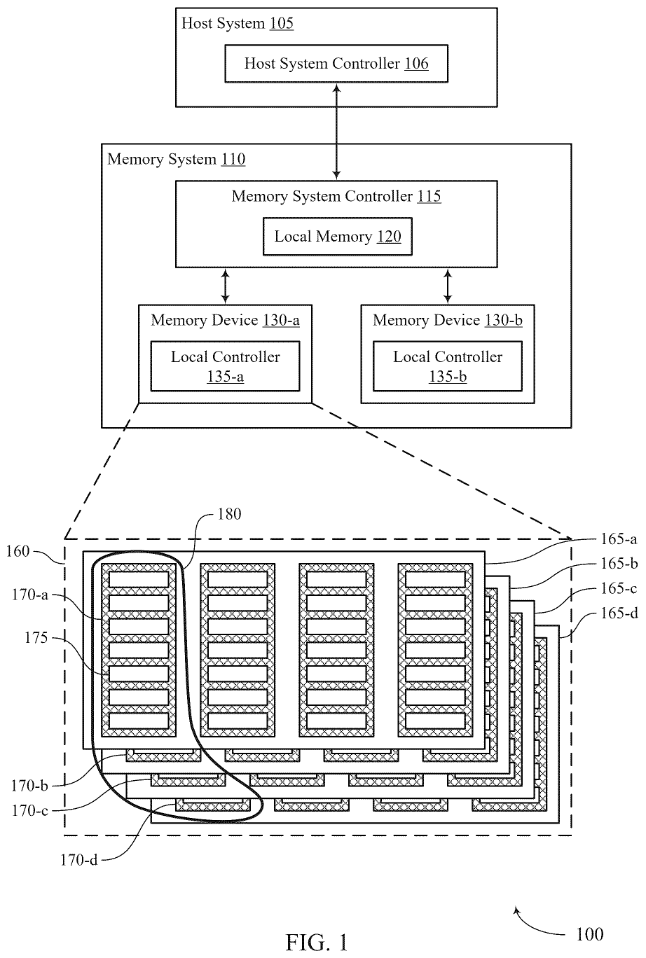

FIG. 1 shows an example of a system 100 that supports data flush techniques for memory in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support data flush techniques for memory. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

To decrease latency with which the memory system 110 may be available for normal operation following a hardware reset operation (e.g., and thus decrease a latency of one or more processes for the system 100, such as a bootup process of the host system 105), the memory system 110 may flush control information from volatile memory (e.g., local memory 120 or other working memory) of the memory system 110 to non-volatile memory (e.g., one or more memory devices 130) in response to receiving the hardware reset signal. By flushing the control information to non-volatile memory before performing the reset operation in response to the hardware reset signal, memory system 110 may be able to reload the control information into volatile memory after the reset operation and begin operating using the reloaded control information, without having to first perform one or more scans or other potentially time-intensive recovery procedures to ensure that the control information is valid for use (e.g., up-to-date). Thus, the extra time taken to flush the control data in its valid state in response to the hardware reset signal may save a relatively greater amount of time after the corresponding hardware reset operation, thereby providing overall time savings and reduced latency in aggregate.

As used herein, flushing information from a source storage location to a target storage location may refer to reading the information from the source storage location (e.g., volatile memory, such as SRAM or other RAM that may be included in local memory 120) and writing that information to the target storage location (e.g., non-volatile memory, such as NAND memory that may be included in one or more memory devices 130). Flushing may not include erasing the information from the source storage location (though such information may be lost from the source storage location if the source location is volatile memory and is subsequently powered down). Flushing data from a source storage location to a target storage location may alternatively be referred to as exporting data from the source storage location to the target storage location.

Also, as used herein, loading information from a source storage location to a target storage location may refer to reading the information from the source storage location (e.g., non-volatile memory, such as NAND memory that may be included in one or more memory devices 130) and writing that information to the target storage location (e. e.g., volatile memory, such as SRAM or other RAM that may be included in local memory 120). Loading may not include erasing the information from the source storage location (though such information may be lost from the source storage location if the source location is volatile memory and is subsequently powered down). Loading data from a source storage location to a target storage location may alternatively be referred to as importing data from the source storage location to the target storage location.

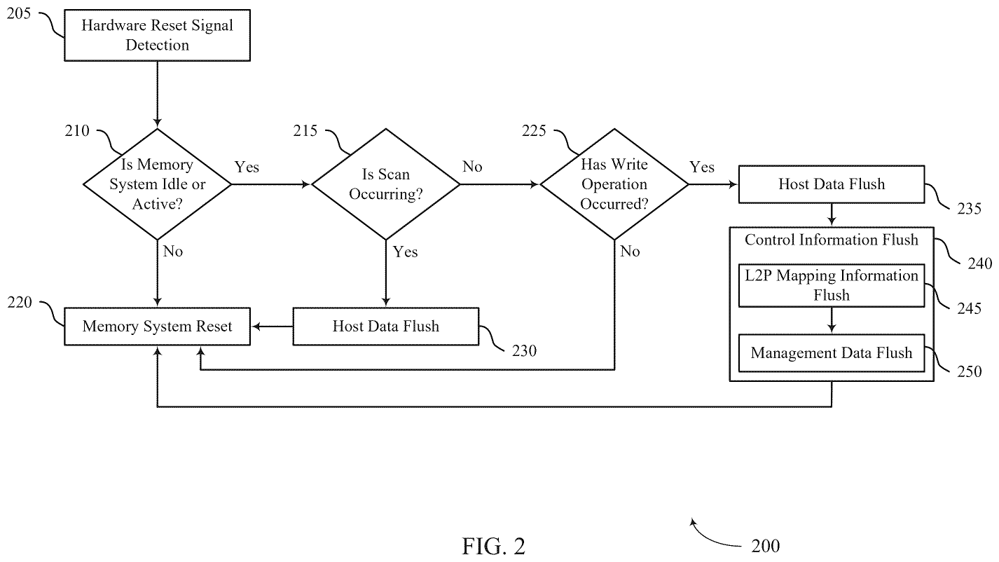

FIG. 2 shows an example of a process flow 200 that supports data flush techniques for memory in accordance with examples as disclosed herein. The process flow 200 may be performed by an example of a memory system 110 as described with reference to FIG. 1, or aspects thereof. In some examples, the memory system may communicate with an example of a host system 105 as described with reference to FIG. 1, or aspects thereof. Aspects of the process flow 200 may be implemented by a controller, among other components. Additionally, or alternatively, aspects of the process flow 200 may be implemented as instructions stored in memory (e.g., firmware stored in a memory coupled with the memory system). For example, the instructions, when executed by a controller (e.g., a memory system controller 115), may cause the controller to perform the operations of the process flow 200.

A memory system (e.g., a NAND-based memory system) may store control information for the memory system within non-volatile (e.g., NAND) memory of the memory system. In some examples, the control information may include information utilized by a controller of the memory system in managing associated memory devices. This information may include L2P mapping information (which may be organized as one or more tables and hence may alternatively be referred to as L2P table data) associated with the memory devices, management data for the memory devices or another component of the memory system, or any combination thereof, among other example types of control information. In some examples, the management data may include one or more types of table data associated with the memory system (e.g., page validity table (PVT) data, valid page count table (VPCT) data, erase count table (ECT) data, read count table (RCT) data, bad block table (BBT) data, or any combination thereof), L2P management data utilized by the memory system for managing (e.g., calculating, searching, inserting, updating) the L2P table data, management data indicating which pages may be in use and in which blocks the pages are stored, or any combination thereof, among other possible types of data that may supper internal operations of the memory system (e.g., operations not commanded by or visible to the host system). As part of an initialization operation (e.g., initialization procedure, such as following a power-up or a hardware reset of the memory system), the memory system may load control information from the non-volatile memory (e.g., one or more memory devices 130) within the memory system to volatile memory within the memory system (e.g., local memory 120), and one or more controllers within the memory system may subsequently operate (e.g., manage) the memory system using (e.g., based on, by executing, in accordance with, or otherwise using) the control information as loaded into and subsequently stored in the volatile memory.

One or more aspects of the control information may change (e.g., be updated) as the memory system operates. For example, as the memory system executes write operations or other operations as commanded by the host system, or as the memory system performs one or more management operations (e.g., garbage collection or wear leveling), aspects of the control information (e.g., L2P mapping information or other management data) may change. Hence, a second version of the control information as stored in volatile memory within the memory system and updated based on (e.g., during) ongoing operation of the memory system may become different (e.g., altered, updated) relative to a first version of the control information that was previously loaded from non-volatile memory within the memory system.

At any point during its operation, the memory system may detect (e.g., receive) a hardware reset signal at 205, in response to which the memory system may perform a memory system reset operation (e.g., after one or more other intervening operations as described herein). In some examples, the hardware reset signal may be or include one or more voltage pulses and may be received via one or more dedicated pins or signal lines, which that may be different than a command interface for receiving commands. For example, the signal may be an example of a hardware reset (e.g., HW Reset) signal as defined in one or more standards (e.g., the UFS standards). A hardware reset signal may be a signal that triggers a hardware reset operation, which may be included in or be an example of a memory reset operation. A hardware reset operation may include a reboot of a memory system 110 in a way that is not subject to potential prevention (e.g., interception) by any software aspects of the memory system 110. In some examples, a hardware reset operation may include a power down of one or more hardware components of the memory system 110 (e.g., of memory system controller 115, of local memory 120, of one or more memory devices 130) followed by a power-on of those one or more hardware components. A hardware reset operation may in some cases be referred to as a hard reset.

As described herein, a memory system may flush the current (e.g., operative, valid, up-to-date) version of the control information from volatile memory within the memory system to non-volatile memory within the memory system in response to (e.g., after) detecting a hardware reset signal, and before performing a hardware reset operation in response to the hardware reset signal. Thus, following the hardware reset operation, the memory system may be able to load (e.g., as part of a subsequent initialization operation), the most recently flushed control information from the non-volatile memory back into the volatile memory within the memory system as described above. The memory system may be able to trust that the most recently flushed control information is valid.

This trust may allow the memory system to skip (e.g., refrain from performing) one or more recovery operations that the memory system may otherwise perform after the hardware reset operation to ensure that it has valid control information. For example, for some memory systems that do not flush the control information in response to a hardware reset signal, such memory systems may perform one or more scans of its non-volatile memory contents or other time-intensive operations to recover (e.g., rebuild) a valid version (e.g., the scanned version described above) of the control information, such as by loading the now-outdated control information (e.g., the first version described above) and updating it based on the results of the one or more scans. Thus, through techniques as described herein, latency associated with recovering from a hardware reset of the memory system may be reduced, among other possible benefits, by avoiding such time-intensive recovery operations.

An example of such techniques is illustrated with respect to FIG. 2. At 205, the memory system may detect a hardware reset signal. For example, the memory system may receive the hardware reset signal from a host system for the memory system.

At 210, the memory system may determine a state of the memory system. For example, in response to receiving the hardware reset signal, the memory system may determine whether the memory system is in an idle state, an active state, a sleep state, a power-down state (e.g., or another type of state). If the memory system determines that the memory system is either an idle state or an active state, then the memory system may proceed to determining at 215 whether a scan (e.g., garbage collection procedure) is ongoing. If the memory system determines that the memory system is not in either an idle state or an active state (e.g., the memory system is instead in a sleep state, a power-down state, or some other state that is not idle or active), then the memory system may perform a memory system reset operation (e.g., hardware reset operation, or other procedure that includes a hardware reset operation) at 220. In some examples, a flush of host data may not be necessary in response to a hardware reset signal if the memory system is in another state other than idle or active because the memory system may perform such a flush of host data before entering such another state, meaning that another flush of host data would be duplicative and unnecessary. Additionally or alternative, for at least some states other than idle or active, the memory system may not be operable to write data to the non-volatile memory while in such a state.

At 215, the memory system may determine whether a scan (or a garbage collection operation or other background management operation) may be occurring. If the memory system is not performing a scan operation, then the memory system may proceed to 225, at which the memory system may determine whether the memory system has performed any write operation during a preceding time period. If the memory system is performing a scan or garbage collection operation, then the memory system may instead perform a host data flush operation at 230, followed by performing a memory reset operation at 220. For the host data flush operation, the memory system may flush data written or otherwise modified by the host system from volatile memory within the memory system to non-volatile memory within the memory system. For example, host data that is modified or new may be stored (e.g., cached, queued) in the volatile memory and may not yet have been written to the non-volatile memory as of the time the hardware reset signal is detected at 205, and at 230, the memory system may flush such host data to non-volatile memory to ensure that such modifications, additions, or other updates to host data are lost due to the memory reset operation. If a scan operation is determined to be ongoing at 215, the memory system may proceed to perform the host data flush followed by the memory reset operation due to a lack of available time to complete the ongoing scan operation as well as any flushes beyond the host data flush (e.g., relative to control information for the memory system, the host data may be a relatively higher priority for flushing). In some examples, the host data flush operation may include the memory system (e.g., or a controller thereof) writing information from the memory system controller's working memory (e.g., SRAM) to the non-volatile memory (e.g., NAND) of the memory system.

At 225, the memory system may determine whether a write operation has occurred (e.g., whether any write command has been received) since a most recent prior memory system reset or initialization operation by the memory system. For example, if no write operation has occurred (e.g., no write command has been received) since the most recent memory system reset or initialization operation, then there may be no updates to the host data or to the control information, such that flushing the host data or the control information may be unnecessary (e.g., the host data and the control information already in non-volatile memory within the memory system may be valid). Accordingly, if the memory system determines at 225 that no write operation has occurred (e.g., no write command has been received) since the most recent memory system reset or initialization operation, then the memory system may proceed to perform a memory system reset operation at 220. If the memory system instead determines at 225 that at least one write operation has occurred (e.g., at least one write command has been received) since the most recent memory system reset or initialization operation, then the memory system may proceed to perform a host data flush operation at 235. The host data flush operation that may be performed at 235 in some operating scenarios may be functionally the same as the host data operation that is performed at 230 in other operating scenarios.

After performing a host data operation at 235, the memory system may perform one or more additional flush operations at 240 to flush control information from volatile memory within the memory system to non-volatile memory within the memory system. Via the one or more additional flush operations at 240, the memory system may flush the control information from the working memory (e.g., volatile memory, SRAM) of the memory system to the non-volatile memory (e.g., NAND) of the memory system. In some examples, as part of the control information flush operation, the memory system may perform, at 245, a L2P mapping information flush operation. For example, the memory system may write the L2P mapping information from the volatile memory of the memory system to the non-volatile memory of the memory system. Additionally, or alternatively, as part of the control information flush operation, the memory system may perform, at 250, a management data flush operation. For example, the memory system may write the management data from the volatile memory of the memory system to the non-volatile memory of the memory system. In some examples, the memory system may store a management data version number (e.g., indicator) in association with (e.g., as part of) the management data that is written to (e.g., flushed to) the non-volatile memory of the memory system. The memory system may increment the management data version number each time the memory system flushes a new version of the management data, such that the management data version number associated with a stored version may indicate whether that version of the management data is valid (e.g., current, up-to-date, operative, usable). Where a flag, as discussed below, indicates that a most recent flush operation for the management data was successful, the memory system may choose a most recent (e.g., highest-numbered) version of the management data for loading into the volatile memory after a hardware reset operation.

In some examples, the memory system may perform the host data flush operation (e.g., at 235), the L2P mapping information flush operation (e.g., at 245), and then the management data flush operation (e.g., at 250) in that order to avoid introducing invalidities into the data or control information (e.g., or both) which may occur if the order of flush operations is changed. For example, dependencies may exist between the respective types of data (e.g., information) that are subject to the flush operations at 235, 245, and 250 (e.g., at least some aspects of the L2P mapping information may depend on the results of flushing the host data, such as the addresses to which the host data is written within the non-volatile memory, and at least some aspects of the management data may depend on the results of flushing the L2P mapping information), and as such performing the flush operations in the order shown in FIG. 2 may maintain validity of the flushed L2P mapping information and management data.

After performing the control information flush operation at 240 (e.g., L2P data flush operation at 245 and management data flush operation at 250), the memory system may perform a memory system reset operation (e.g., hardware reset operation) at 220. Thus, in response a hardware reset signal, the memory system may perform a control information flush operation (e.g., along with one or more other operations) before performing the memory reset operation.

In some examples, as part of flushing the management data at 250, the memory system may set a flag (e.g., indicator) within the flushed version of the management data to indicate whether the flushed version of the control information is valid (e.g., up-to-date, successfully flushed). For example, in cases that the memory system may successfully perform each of the flush operations at 245 and 250, the memory system may set the internal flag to indicate that the flushed control information is valid (e.g., the memory system may set the internal flag to “1”). Alternatively, in cases where the memory system may not successfully perform one or more of the flush operation at 245 or 250 (e.g., due to inadequate time, due to a system malfunction), the memory system may set the internal flag to indicate that the flushed control information is invalid (e.g., the memory system may set the internal flag to “0”). Following a memory system reset operation, the memory system may check the value of the flag. If the flag indicates that the control information as flushed prior to the reset operation is valid (e.g., the flag is set to “1”), then the memory system may load the most recently flushed version of the control information from the non-volatile memory in the volatile memory and avoid one or more recovery operations (e.g., scans or other operations as discussed elsewhere herein). If, however, the flag indicates that the control information as flushed prior to the reset operation is invalid (e.g., the flag is set to “0”), then the memory system may perform the one or more recovery operations to recover (e.g., rebuild) the control information based on an older version of the control information.

After performing the memory reset operation at 220, the memory system may perform an initialization operation, after which the memory system may be ready to resume normal operation (e.g., to perform access operations or other operations in response to commands or other signaling from the host system).

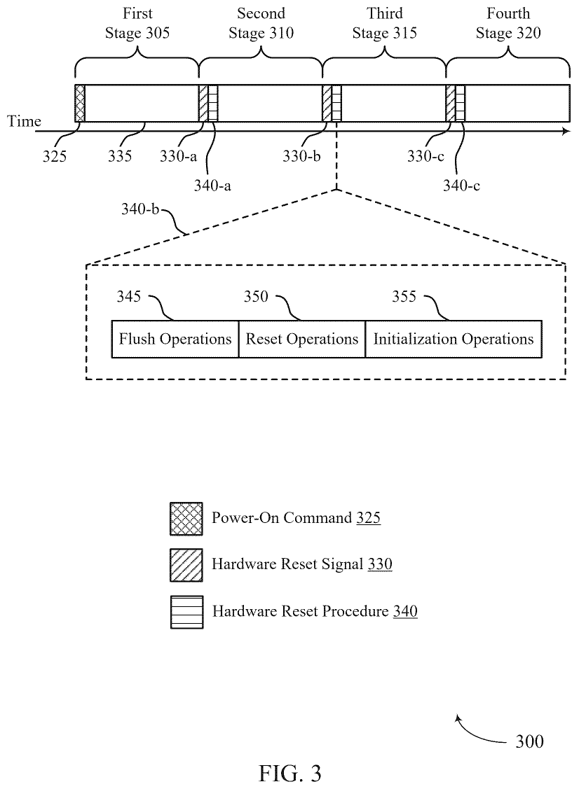

FIG. 3 shows an example of a timing diagram 300 that supports data flush techniques for memory in accordance with examples as disclosed herein. Operations corresponding to the timing diagram 300 may be performed by an example of a memory system 110 and a host system 105 as described with reference to FIG. 1, or aspects thereof.

The timing diagram 300 may depict an example bootup process for a host system that includes the issuance by the host system of multiple hardware reset signals 330 to the memory system. The memory system may perform a hardware reset procedure 340 in response to each hardware reset signal 330 issued by the host system. The hardware reset procedure 340 may include the operations of process flow 200 as described herein (e.g., flush operations 345 may include one or more of a host data flush operation, an L2P mapping information flush operation, and a management data flush operations as described with reference to FIG. 2, and reset operations 350 may be or include a memory reset operation as described with reference to FIG. 2) followed by one or more initialization operations 355. Because a hardware reset procedure 340 as described herein may have reduced latency (e.g., due to flushing of the control information and associated avoidance of one or more time-intensive recovery operations that may otherwise be performed to recover valid control information), a bootup or other process for a host system that includes the issuance of one or more hardware reset signals 330 may correspondingly have reduced latency, improved reliability, or other potential benefits.

In some examples, the host bootup process may include a first stage 305. During the first stage 305, the host system may communicate a power-on command 325 to the memory system. The memory system, in response to receiving the power-on command 325, may load control information (e.g., L2P mapping information, management data, or any combination thereof) from non-volatile memory of the memory system (e.g., NAND memory) to volatile memory of the memory system (e.g., SRAM, working memory). In some examples, as part of the first stage 305 of the host bootup process, the host system may issue one or more read commands to the memory system, in response to which the memory system may perform one or more read operations (e.g., from the non-volatile memory of the memory system).

The host bootup process may also include a second stage 310. During the second stage 310, the memory system may receive a hardware reset signal 330-a (e.g., from the host system). In response to the hardware reset signal 330-a, the memory system may perform a hardware reset procedure 340-a. In some cases, due to no write commands being issued by the host system and hence no write operations being performed by the memory system during the first stage 305, the hardware reset procedure 340-a may not include any flush operations 345 (e.g., the memory system may determine that no write operation has occurred since the prior initialization in response to the power-on command 325, as described for example with reference to 225 of FIG. 2), though the memory system may still perform one or more reset operations 350 and one or more initialization operations 355 as part of the hardware reset procedure 340-a. In some examples, as part of the second stage 310 of the host bootup process, the host system may issue one or more read commands and one or more write commands to the memory system, in response to which the memory system may perform one or more read operations and one or more write operations (e.g., from/to the non-volatile memory of the memory system).

In some cases, the host bootup process may also include a third stage 315. During the third stage 315, the memory system may receive a hardware reset signal 330-b (e.g., from the host system). In response to the hardware reset signal 330-b, the memory system may perform a hardware reset procedures 340-b. For example, in response to receiving the hardware reset signal 330-b, the memory system may perform one or more flush operations 345 (e.g., due to one or more write operations having been performed in connection with the second stage 310). The memory system may also set a flag (e.g., to “1”) to indicate that the flush operations 345 were successful. Subsequent to performing the one or more flush operations 345, and in response to the hardware reset signal 330-b, the memory system may perform one or more reset operations 350 and one or more initialization operations 355 to initialize the host system. As part of the one or more initialization operations 355 included in the hardware reset procedure 340-b, based on the flag having been set, the memory system may load into volatile memory the control information that was flushed as part of the flush operations 345 included in the hardware reset procedure 340-a. In cases where the flag is instead not set (e.g., is “0”), then the memory system may instead recover the control information based on some earlier version of the control information (earlier than the version that was flushed as part of the flush operations 345 included in the hardware reset procedure 340-a). In some examples, as part of the third stage 315 of the host bootup process, the host system may issue one or more read commands and one or more write commands to the memory system, in response to which the memory system may perform one or more read operations and one or more write operations (e.g., from/to the non-volatile memory of the memory system).

In some cases, the host bootup process may also include a fourth stage 320. During the fourth stage 320, the memory system may receive a hardware reset signal 330-c (e.g., from the host system). In response to the hardware reset signal 330-c, the memory system may perform a hardware reset procedure 340-c. For example, in response to receiving the hardware reset signal 330-c, the memory system may perform one or more flush operations 345 (e.g., due to one or more write operations having been performed in connection with the third stage 315). The memory system may also set a flag (e.g., to “1”) to indicate that the flush operations 345 were successful. Subsequent to performing the one or more flush operations 345, and in response to the hardware reset signal 330-c, the memory system may perform one or more reset operations 350 and one or more initialization operations 355 to initialize the host system. As part of the one or more initialization operations 355 included in the hardware reset procedure 340-b, based on the flag having been set, the memory system may load into volatile memory the control information that was flushed as part of the flush operations 345 included in the hardware reset procedure 340-a. In cases where the flag is instead not set (e.g., is “0”), then the memory system may instead recover the control information based on some earlier version of the control information (earlier than the version that was flushed as part of the flush operations 345 included in the hardware reset procedure 340-a). In some examples, as part of the fourth stage 320 of the host bootup process, the host system may issue one or more read commands and one or more write commands to the memory system, in response to which the memory system may perform one or more read operations and one or more write operations (e.g., from/to the non-volatile memory of the memory system).

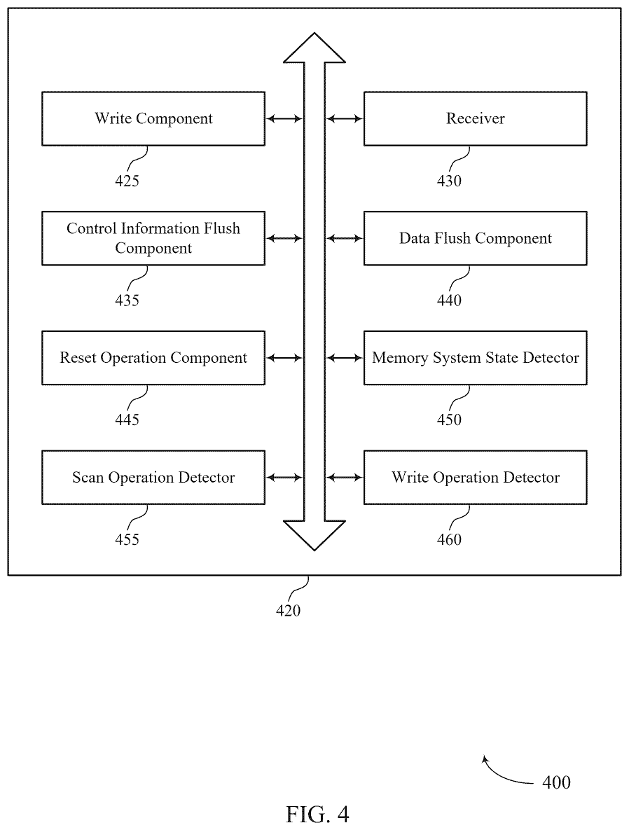

FIG. 4 shows a block diagram 400 of a memory system 420 that supports data flush techniques for memory in accordance with examples as disclosed herein. The memory system 420 may be an example of aspects of a memory system as described with reference to FIGS. 1 through 3. The memory system 420, or various components thereof, may be an example of means for performing various aspects of data flush techniques for memory as described herein. For example, the memory system 420 may include a write component 425, a receiver 430, a control information flush component 435, a data flush component 440, a reset operation component 445, a memory system state detector 450, a scan operation detector 455, a write operation detector 460, or any combination thereof. Each of these components, or components of subcomponents thereof (e.g., one or more processors, one or more memories), may communicate, directly or indirectly, with one another (e.g., via one or more buses).

The write component 425 may be configured as or otherwise support a means for writing, within a memory system including RAM and NAND memory, control information for the memory system from the NAND memory to the random access memory. The receiver 430 may be configured as or otherwise support a means for receiving, at the memory system, a hardware reset signal. The control information flush component 435 may be configured as or otherwise support a means for flushing the control information for the memory system from the random access memory to the NAND memory in response to the hardware reset signal.

In some examples, the data flush component 440 may be configured as or otherwise support a means for flushing data associated with a host for the memory system from the random access memory to the NAND memory in response to the hardware reset signal, where flushing the control information for the memory system occurs after flushing the data associated with the host.

In some examples, the reset operation component 445 may be configured as or otherwise support a means for performing, after flushing the control information for the memory system from the random access memory to the NAND memory, a memory system reset operation in response to the hardware reset signal.

In some examples, the memory system state detector 450 may be configured as or otherwise support a means for determining, in response to the hardware reset signal, whether the memory system is in an idle state or an active state, where flushing the control information for the memory system from the random access memory to the NAND memory is based at least in part on determining that the memory system is in the idle state or the active state.

In some examples, the scan operation detector 455 may be configured as or otherwise support a means for determining, in response to the hardware reset signal, whether a scan operation is being performed within the memory system, where flushing the control information for the memory system from the random access memory to the NAND memory is based at least in part on determining that the scan operation is not being performed.

In some examples, the write operation detector 460 may be configured as or otherwise support a means for determining, in response to the hardware reset signal, whether any write operation has occurred since a prior reset operation or initialization operation of the memory system, where flushing the control information for the memory system from the random access memory to the NAND memory is based at least in part on determining that at least one write operation has occurred since the prior reset operation or initialization operation of the memory system.

In some examples, the control information for the memory system includes L2P mapping information for the NAND memory, management data for the NAND memory, or any combination thereof.

In some examples, to support flushing the control information for the memory system from the random access memory to the NAND memory, the control information flush component 435 may be configured as or otherwise support a means for flushing the L2P mapping information to the NAND memory prior to flushing the management data to the NAND memory.

In some examples, writing the control information for the memory system from the NAND memory to the random access memory is based at least in part on a bootup operation sequence for a host of the memory system.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

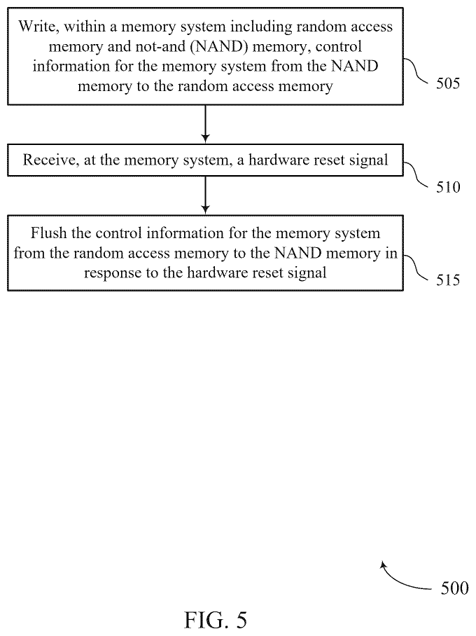

FIG. 5 shows a flowchart illustrating a method 500 that supports data flush techniques for memory in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include writing, within a memory system including RAM and NAND memory, control information for the memory system from the NAND memory to the random access memory. In some examples, aspects of the operations of 505 may be performed by a write component 425 as described with reference to FIG. 4.

At 510, the method may include receiving, at the memory system, a hardware reset signal. In some examples, aspects of the operations of 510 may be performed by a receiver 430 as described with reference to FIG. 4.

At 515, the method may include flushing the control information for the memory system from the random access memory to the NAND memory in response to the hardware reset signal. In some examples, aspects of the operations of 515 may be performed by a control information flush component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for writing, within a memory system including RAM and NAND memory, control information for the memory system from the NAND memory to the random access memory; receiving, at the memory system, a hardware reset signal; and flushing the control information for the memory system from the random access memory to the NAND memory in response to the hardware reset signal.

Aspect 2: The method, apparatus, or non-transitory computer-readable medium of aspect 1, further including operations, features, circuitry, logic, means, or instructions, or any combination thereof for flushing data associated with a host for the memory system from the random access memory to the NAND memory in response to the hardware reset signal, where flushing the control information for the memory system occurs after flushing the data associated with the host.

Aspect 3: The method, apparatus, or non-transitory computer-readable medium of any of aspects 1 through 2, further including operations, features, circuitry, logic, means, or instructions, or any combination thereof for performing, after flushing the control information for the memory system from the random access memory to the NAND memory, a memory system reset operation in response to the hardware reset signal.

Aspect 4: The method, apparatus, or non-transitory computer-readable medium of any of aspects 1 through 3, further including operations, features, circuitry, logic, means, or instructions, or any combination thereof for determining, in response to the hardware reset signal, whether the memory system is in an idle state or an active state, where flushing the control information for the memory system from the random access memory to the NAND memory is based at least in part on determining that the memory system is in the idle state or the active state.

Aspect 5: The method, apparatus, or non-transitory computer-readable medium of any of aspects 1 through 4, further including operations, features, circuitry, logic, means, or instructions, or any combination thereof for determining, in response to the hardware reset signal, whether a scan operation is being performed within the memory system, where flushing the control information for the memory system from the random access memory to the NAND memory is based at least in part on determining that the scan operation is not being performed.

Aspect 6: The method, apparatus, or non-transitory computer-readable medium of any of aspects 1 through 5, further including operations, features, circuitry, logic, means, or instructions, or any combination thereof for determining, in response to the hardware reset signal, whether any write operation has occurred since a prior reset operation or initialization operation of the memory system, where flushing the control information for the memory system from the random access memory to the NAND memory is based at least in part on determining that at least one write operation has occurred since the prior reset operation or initialization operation of the memory system.

Aspect 7: The method, apparatus, or non-transitory computer-readable medium of any of aspects 1 through 6, where the control information for the memory system includes L2P mapping information for the NAND memory, management data for the NAND memory, or any combination thereof.

Aspect 8: The method, apparatus, or non-transitory computer-readable medium of aspect 7, where flushing the control information for the memory system from the random access memory to the NAND memory includes operations, features, circuitry, logic, means, or instructions, or any combination thereof for flushing the L2P mapping information to the NAND memory prior to flushing the management data to the NAND memory.

Aspect 9: The method, apparatus, or non-transitory computer-readable medium of any of aspects 1 through 8, where writing the control information for the memory system from the NAND memory to the random access memory is based at least in part on a bootup operation sequence for a host of the memory system.

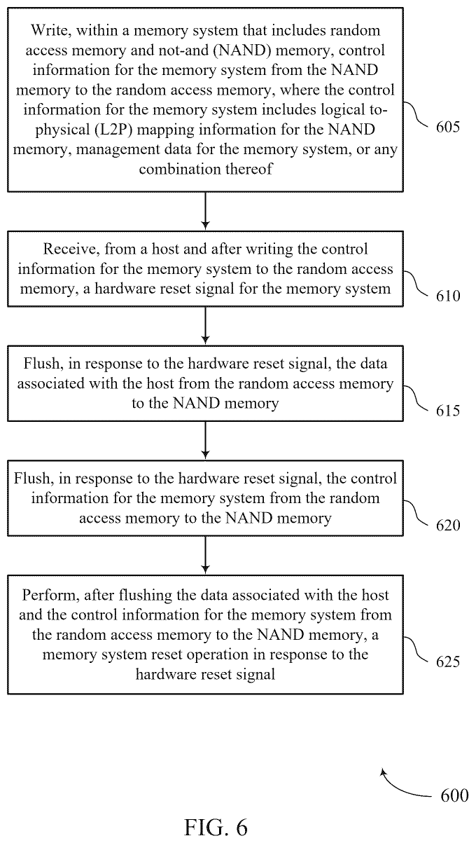

FIG. 6 shows a flowchart illustrating a method 600 that supports data flush techniques for memory in accordance with examples as disclosed herein. The operations of method 600 may be implemented by a memory device or its components as described herein. For example, the operations of method 600 may be performed by a memory device as described with reference to FIGS. 1 through 4. In some examples, a memory device may execute a set of instructions to control the functional elements of the device to perform the described functions. Additionally, or alternatively, the memory device may perform aspects of the described functions using special-purpose hardware.

At 605, the method may include writing, within a memory system that includes RAM and NAND memory, control information for the memory system from the NAND memory to the random access memory, where the control information for the memory system includes L2P mapping information for the NAND memory, management data for the memory system, or any combination thereof. In some examples, aspects of the operations of 605 may be performed by a write component 425 as described with reference to FIG. 4.

At 610, the method may include receiving, from a host and after writing the control information for the memory system to the random access memory, a hardware reset signal for the memory system. In some examples, aspects of the operations of 610 may be performed by a receiver 430 as described with reference to FIG. 4.

At 615, the method may include flushing, in response to the hardware reset signal, the data associated with the host from the random access memory to the NAND memory. In some examples, aspects of the operations of 615 may be performed by a data flush component 440 as described with reference to FIG. 4.

At 620, the method may include flushing, in response to the hardware reset signal, the control information for the memory system from the random access memory to the NAND memory. In some examples, aspects of the operations of 620 may be performed by a control information flush component 435 as described with reference to FIG. 4.

At 625, the method may include performing, after flushing the data associated with the host and the control information for the memory system from the random access memory to the NAND memory, a memory system reset operation in response to the hardware reset signal. In some examples, aspects of the operations of 625 may be performed by a reset operation component 445 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 10: A method, apparatus, or non-transitory computer-readable medium including operations, features, circuitry, logic, means, or instructions, or any combination thereof for writing, within a memory system that includes RAM and NAND memory, control information for the memory system from the NAND memory to the random access memory, where the control information for the memory system includes L2P mapping information for the NAND memory, management data for the memory system, or any combination thereof; receiving, from a host and after writing the control information for the memory system to the random access memory, a hardware reset signal for the memory system; flushing, in response to the hardware reset signal, the data associated with the host from the random access memory to the NAND memory; flushing, in response to the hardware reset signal, the control information for the memory system from the random access memory to the NAND memory; and performing, after flushing the data associated with the host and the control information for the memory system from the random access memory to the NAND memory, a memory system reset operation in response to the hardware reset signal.

Aspect 11: The method, apparatus, or non-transitory computer-readable medium of aspect 10, further including operations, features, circuitry, logic, means, or instructions, or any combination thereof for determining, in response to the hardware reset signal, whether the memory system is in an idle state or an active state, where flushing the control information for the memory system from the random access memory to the NAND memory is based at least in part on determining that the memory system is in the idle state or the active state.

Aspect 12: The method, apparatus, or non-transitory computer-readable medium of any of aspects 10 through 11, further including operations, features, circuitry, logic, means, or instructions, or any combination thereof for determining, in response to the hardware reset signal, whether a scan operation is being performed within the memory system, where flushing the control information for the memory system from the random access memory to the NAND memory is based at least in part on determining that the scan operation is not being performed.

Aspect 13: The method, apparatus, or non-transitory computer-readable medium of any of aspects 10 through 12, further including operations, features, circuitry, logic, means, or instructions, or any combination thereof for determining, in response to the hardware reset signal, whether any write operation has occurred since a prior reset operation or initialization operation of the memory system, where flushing the control information for the memory system from the random access memory to the NAND memory is based at least in part on determining that at least one write operation has occurred since the prior reset operation or initialization operation of the memory system.

Aspect 14: The method, apparatus, or non-transitory computer-readable medium of any of aspects 10 through 13, where flushing the control information for the memory system from the random access memory to the NAND memory includes operations, features, circuitry, logic, means, or instructions, or any combination thereof for flushing the L2P mapping information to the NAND memory prior to flushing the management data to the NAND memory.

Aspect 15: The method, apparatus, or non-transitory computer-readable medium of any of aspects 10 through 14, where writing the control information for the memory system from the NAND memory to the random access memory is based at least in part on a bootup operation sequence for a host of the memory system.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
processing circuitry associated with a memory system comprising random access memory and not-and (NAND) memory, the processing circuitry configured to cause the apparatus to:
write control information for the memory system from the NAND memory of the memory system to the random access memory of the memory system;
receive, at the memory system, a hardware reset signal; and
flush the control information for the memory system from the random access memory to the NAND memory in response to the hardware reset signal.

2. The apparatus of claim 1, wherein the processing circuitry is further configured to cause the apparatus to:
flush data associated with a host for the memory system from the random access memory to the NAND memory in response to the hardware reset signal, wherein the processing circuitry is configured to cause the apparatus to flush the control information for the memory system after flushing the data associated with the host.

3. The apparatus of claim 1, wherein the processing circuitry is further configured to cause the apparatus to:
perform, after flushing the control information for the memory system from the random access memory to the NAND memory, a memory system reset operation in response to the hardware reset signal.

4. The apparatus of claim 1, wherein the processing circuitry is further configured to cause the apparatus to:
determine, in response to the hardware reset signal, whether the memory system is in an idle state or an active state, wherein the processing circuitry is configured to cause the apparatus to flush the control information for the memory system from the random access memory to the NAND memory based at least in part on determining that the memory system is in the idle state or the active state.

5. The apparatus of claim 1, wherein the processing circuitry is further configured to cause the apparatus to:
determine, in response to the hardware reset signal, whether a scan operation is being performed within the memory system, wherein the processing circuitry is configured to cause the apparatus to flush the control information for the memory system from the random access memory to the NAND memory based at least in part on determining that the scan operation is not being performed.

6. The apparatus of claim 1, wherein the processing circuitry is further configured to cause the apparatus to:
determine, in response to the hardware reset signal, whether any write operation has occurred since a prior reset operation or initialization operation of the memory system, wherein the processing circuitry is configured to cause the apparatus to flush the control information for the memory system from the random access memory to the NAND memory based at least in part on determining that at least one write operation has occurred since the prior reset operation or initialization operation of the memory system.

7. The apparatus of claim 1, wherein the control information for the memory system comprises logical to-physical (L2P) mapping information for the NAND memory, management data for the NAND memory, or any combination thereof.

8. The apparatus of claim 7, wherein, to flush the control information for the memory system from the random access memory to the NAND memory, the processing circuitry is configured to cause the apparatus to:
flush the L2P mapping information to the NAND memory prior to flushing the management data to the NAND memory.

9. The apparatus of claim 1, wherein the processing circuitry is configured to cause the apparatus to write the control information for the memory system from the NAND memory to the random access memory based at least in part on a bootup operation sequence for a host of the memory system.

10. A non-transitory computer-readable medium storing code, the code comprising instructions executable by one or more processors to:
write, within a memory system comprising random access memory and not-and (NAND) memory, control information for the memory system from the NAND memory to the random access memory;
receive, at the memory system, a hardware reset signal; and
flush the control information for the memory system from the random access memory to the NAND memory in response to the hardware reset signal.

11. The non-transitory computer-readable medium of claim 10, wherein the instructions are further executable by the one or more processors to:
flush data associated with a host for the memory system from the random access memory to the NAND memory in response to the hardware reset signal, wherein the instructions are executable by the one or more processors to flush the control information for the memory system after flushing the data associated with the host.

12. The non-transitory computer-readable medium of claim 10, wherein the instructions are further executable by the one or more processors to:
perform, after flushing the control information for the memory system from the random access memory to the NAND memory, a memory system reset operation in response to the hardware reset signal.

13. The non-transitory computer-readable medium of claim 10, wherein the instructions are further executable by the one or more processors to:
determine, in response to the hardware reset signal, whether the memory system is in an idle state or an active state, wherein the instructions are executable by the one or more processors to flush the control information for the memory system from the random access memory to the NAND memory based at least in part on determining that the memory system is in the idle state or the active state.

14. The non-transitory computer-readable medium of claim 10, wherein the instructions are further executable by the one or more processors to:
determine, in response to the hardware reset signal, whether a scan operation is being performed within the memory system, wherein the instructions are executable by the one or more processors to flush the control information for the memory system from the random access memory to the NAND memory based at least in part on determining that the scan operation is not being performed.

15. The non-transitory computer-readable medium of claim 10, wherein the instructions are further executable by the one or more processors to:
determine, in response to the hardware reset signal, whether any write operation has occurred since a prior reset operation or initialization operation of the memory system, wherein the instructions are executable by the one or more processors to flush the control information for the memory system from the random access memory to the NAND memory based at least in part on determining that at least one write operation has occurred since the prior reset operation or initialization operation of the memory system.

16. The non-transitory computer-readable medium of claim 10, wherein the control information for the memory system comprises logical to-physical (L2P) mapping information for the NAND memory, management data for the NAND memory, or any combination thereof.

17. The non-transitory computer-readable medium of claim 16, wherein, to flush the control information for the memory system from the random access memory to the NAND memory, the instructions are executable by the one or more processors to:
flush the L2P mapping information to the NAND memory prior to flushing the management data to the NAND memory.

18. The non-transitory computer-readable medium of claim 10, wherein the instructions are executable by the one or more processors to write the control information for the memory system from the NAND memory to the random access memory based at least in part on a bootup operation sequence for a host of the memory system.

19. A method, comprising:
writing, within a memory system comprising random access memory and not-and (NAND) memory, control information for the memory system from the NAND memory to the random access memory;
receiving, at the memory system, a hardware reset signal; and
flushing the control information for the memory system from the random access memory to the NAND memory in response to the hardware reset signal.

20. The method of claim 19, further comprising:
flushing data associated with a host for the memory system from the random access memory to the NAND memory in response to the hardware reset signal, wherein flushing the control information for the memory system occurs after flushing the data associated with the host.

21. The method of claim 19, further comprising:
performing, after flushing the control information for the memory system from the random access memory to the NAND memory, a memory system reset operation in response to the hardware reset signal.

22. The method of claim 19, further comprising:
determining, in response to the hardware reset signal, whether the memory system is in an idle state or an active state, wherein flushing the control information for the memory system from the random access memory to the NAND memory is based at least in part on determining that the memory system is in the idle state or the active state.

23. The method of claim 19, further comprising:
determining, in response to the hardware reset signal, whether a scan operation is being performed within the memory system, wherein flushing the control information for the memory system from the random access memory to the NAND memory is based at least in part on determining that the scan operation is not being performed.

24. The method of claim 19, further comprising:
determining, in response to the hardware reset signal, whether any write operation has occurred since a prior reset operation or initialization operation of the memory system, wherein flushing the control information for the memory system from the random access memory to the NAND memory is based at least in part on determining that at least one write operation has occurred since the reset operation or the initialization operation of the memory system.

25. The method of claim 19, wherein the control information for the memory system comprises logical to-physical (L2P) mapping information for the NAND memory, management data for the NAND memory, any combination thereof.

26. The method of claim 25, wherein flushing the control information for the memory system from the random access memory to the NAND memory comprises:
flushing the L2P mapping information to the NAND memory prior to flushing the management data to the NAND memory.

27. The method of claim 19, wherein writing the control information for the memory system from the NAND memory to the random access memory is based at least in part on a bootup operation sequence for a host of the memory system.

28. An apparatus, comprising:
processing circuitry associated with a memory system that comprises random access memory and not-and (NAND) memory, the processing circuitry configured to cause the apparatus to:
write control information for the memory system from the NAND memory of the memory system to the random access memory of the memory system, wherein the control information for the memory system comprises logical to-physical (L2P) mapping information for the NAND memory, management data for the memory system, or any combination thereof;
receive, from a host and after writing the control information for the memory system to the random access memory, a hardware reset signal for the memory system;
flush, in response to the hardware reset signal, the data associated with the host from the random access memory to the NAND memory;
flush, in response to the hardware reset signal, the control information for the memory system from the random access memory to the NAND memory; and
perform, after flushing the data associated with the host and the control information for the memory system from the random access memory to the NAND memory, a memory system reset operation in response to the hardware reset signal.

29. The apparatus of claim 28, wherein the processing circuitry is further configured to cause the apparatus to:
determine, in response to the hardware reset signal, whether the memory system is in an idle state or an active state, wherein the processing circuitry is configured to cause the apparatus to flush the control information for the memory system from the random access memory to the NAND memory based at least in part on determining that the memory system is in the idle state or the active state.

30. The apparatus of claim 28, wherein the processing circuitry is further configured to cause the apparatus to:
determine, in response to the hardware reset signal, whether a scan operation is being performed within the memory system, wherein the processing circuitry is configured to cause the apparatus to flush the control information for the memory system from the random access memory to the NAND memory based at least in part on determining that the scan operation is not being performed.

31. The apparatus of claim 28, wherein the processing circuitry is further configured to cause the apparatus to:
determine, in response to the hardware reset signal, whether any write operation has occurred since a prior reset operation or initialization operation of the memory system, wherein the processing circuitry is configured to cause the apparatus to flush the control information for the memory system from the random access memory to the NAND memory based at least in part on determining that at least one write operation has occurred since the prior reset operation or initialization operation of the memory system.

32. The apparatus of claim 28, wherein, to flush the control information for the memory system from the random access memory to the NAND memory, the processing circuitry is configured to cause the apparatus to:
flush the L2P mapping information to the NAND memory prior to flushing the management data to the NAND memory.

33. The apparatus of claim 28, wherein the processing circuitry is configured to cause the apparatus to write the control information for the memory system from the NAND memory to the random access memory based at least in part on a bootup operation sequence for a host of the memory system.
